(19) United States
(12) Patent Application Publication
(10) Pub. No.: US 2004/0202003 A1
(43) Pub. Date: Oct. 14, 2004

(54) SELECTIVE OUTPUT WAVE-GUIDE

(75) Inventor: James E. Lyst JR., Indianapolis, IN (US)

Correspondence Address: ICE MILLER, ONE AMERICAN SQUARE, BOX 82001, INDIANAPOLIS, IN, 46282, US

(73) Assignee: GUIDE CORPORATION, Pendleton, IN (US)

(21) Appl. No.: 10/249,470

(22) Filed: Apr. 11, 2003

(51) Int. Cl. F21V 7/04; F21V 8/00

(52) U.S. Cl. 362/511; 362/560

(57) ABSTRACT

The subject invention comprises a lighting assembly that utilizes the combination of a wave-guide and a Fresnel prism to advantageously direct light emitted from a light source. An exemplary embodiment of the subject invention comprises a light source, a wedge shaped wave-guide and a Fresnel prism. Another exemplary embodiment of the subject invention comprises a light source, a Fresnel wave-guide and a Fresnel prism. In either embodiment, light emitted from the light source passes either from the light source into the wave-guide or through a light pipe into the wave-guide. The wave-guide will select the exiting angle of the light rays so that the light will emit from the wave-guide at approximately the same angle and pass into the Fresnel prism. The Fresnel prism will cause the light to be emitted from the lighting assembly at nearly a normal angle.

### BACKGROUND OF INVENTION

The subject invention relates generally to lighting systems that utilize optical devices for guiding light. More specifically, the present invention relates to lighting systems used in various applications, such as vehicles.

Generally, a typical vehicular lamp is an assembly of three primary components, an opaque housing portion (usually recessed into the body of a vehicle) having an open end and a reflector configured to retain a light bulb, a light transmissive and diffusing lens portion affixed to the open front of the housing, and at least one light source. The purpose of the reflector is to forwardly concentrate the light emitted from the light source. To achieve this result, the reflector housing typically has a silvered or reflective parabolic surface which is intersected by a central bore comprising a bulb access aperture. Reflectors may be constructed of metal or plastic, so long as the surface is made reflective in some fashion to effectively reflect light. Generally, the front profile of such vehicular lamps is substantially parabolic or elliptical. However, the profile is not limited to these shapes and can take the form of other shapes, so long as, the vehicular lamp adequately reflects and projects light. Although the volume of vehicular lamp assemblies vary depending on the lamp shape, vehicular lamp assemblies usually have an approximate volume of a cubic foot.

Several disadvantages exist in vehicular lamp assemblies of this construction. For example, these types of vehicular lamps limit vehicle design options because they require a set amount of space in a vehicle, which cannot be further reduced in size or volume. Further, these types of lamps are inefficient in directing and collecting light as they rely merely on reflective surfaces to direct the light rays emitted from the light bulb. Another drawback is that these types of lamps use traditional wiring, wiring harnesses, and wiring insulation. Such wiring is susceptible to wear and corrosion, which leads to less efficient conduction of electricity and may lead to an increased risk of shock and fire hazard.

In an effort to overcome these limitations, lamp manufacturers have applied fiber optic technology to vehicular lighting systems. Fiber optics is a branch of optics dealing with the transmission of light through glass or some other transparent material having a high refractive index. Typically, such materials are configured into fibers or thin rods (“light pipes”) and wave-guides. As used herein, the term “wave-guide” means a single medium with a single index of refraction that allows light rays to pass into the single medium through its light admitting end and causes the light rays to internally reflect along a path defined by its physical construction until the light rays exit the single medium at an angle less than a critical angle. As used herein, the term “critical angle” refers to the boundary where a light ray will stop reflecting off a surface and start being refracted by that surface. Fiber optics and wave-guides rely on the physics of total internal reflection. Total internal reflection allows light rays to travel great distances. In this phenomenon, light rays travel inside a medium that has a greater density than its surroundings. Whenever a light ray traveling through a medium strikes the interface between the medium and the medium's surroundings at an angle greater than the critical angle, it is completely reflected toward the inside of the medium without loss. Thus, light from a light source can be transmitted over long distances by being reflected inward thousands of times. This phenomenon is quantified by Snell's law, a law of geometric optics that defines the amount of bending that takes place when a light ray strikes a refractive boundary, e.g., an air-glass interface, at a non-normal angle.

In general, Snell's law states that:

n₁ sin θ₁=n₂ sin θ₂

where n₁ is the index of refraction of the medium in which the incident ray travels; θ₁ is the angle, with respect to the normal angle at the refractive boundary, at which the incident ray strikes the boundary; n₂ is the index of refraction of the medium in which the refracted ray travels; and θ₂ is the angle, with respect to the normal angle at the refractive boundary, at which the refracted ray travels. If the incident ray travels in a medium of higher refractive index toward a medium of lower refractive index at such an angle that Snell's law would call for the sine of the reflected ray to be greater than unity,

(n₂ *sin θ₂)/n₁=sin θ₁>1

then the “refracted” ray in actuality becomes a reflected ray and is totally reflected back into the medium of higher refractive index, at an angle equal to the incident angle. This reflection occurs even in the absence of a metallic reflective coating.

Fiber optics are most commonly used in telecommunications, in computer graphics, and in applications to transmit light in vehicles, aircrafts, and medical equipment. The potential of fiber optic applications in these fields is nearly unlimited because the light sent through fiber optic assemblies is virtually unaffected by many environmental interferences, i.e., pressure, sound waves, heat, motion, electromagnetic interference (from lightning, nearby electric motors, and similar sources) and interference from adjoining wires. Additionally, a fiber optic cable is easy to handle and to install, because a fiber optic cable, even one that contains many fibers, is usually much smaller and lighter in weight than a wire or coaxial cable with similar carrying capacity. It is these characteristics that make fiber optic wiring advantageous to use over traditional wiring.

Optical fibers can be especially useful where electrical effects could make ordinary wiring useless, less accurate, or even hazardous. The basic fiber is made of glass or other clear materials that will not corrode in the presence of most chemicals. Thus, fiber optics can be exposed to most corrosive atmospheres without significant concern of corrosion. Even in the most explosive of atmospheres, there is no fire hazard or danger of electrical shock to personnel repairing broken fibers, because the only thing transferred through the fiber is light. Thus, no danger of sparking exists when a fiber is broken.

While these advantages have made fiber optics desirable, one problem has plagued the use of fiber optics in lighting systems. Fiber optic systems fail to efficiently and effectively direct and collect the light rays that are emitted from a light source or a light pipe. As shown in FIG. 1, one fiber optic lighting system 10 has tried to solve this problem by utilizing a series of cuts or grooves 12 on the surface of a light pipe 11 to dispense and direct the light. However, this approach provides only a low degree of angular control as it relies solely on the geometry and location of the cuts or groves.

As shown in FIG. 2, another example of a planar fiber optic lighting system 15 utilizes a planer wave-guide 16 affixed at the end of a light pipe 17. Planar wave-guide 16 collects the emitted light from light pipe 17 and reflects the light out of face 19 of the planar wave-guide via angled surfaces 18. This approach enables a construction of a relatively flat lamp with some light control and the ability to use multiple light sources for illumination. However, angular control of the light is difficult and angular output of the light is weak.

Therefore, it is desirable to provide a fiber optic lighting assembly that provides for improved and reliable angular control and output, in order to allow for more efficient use of the light emitted from a light source. It is further desired that such a fiber optic lighting assembly be able to provide a thin lamp assembly in order to increase the design flexibility in all lighting systems. It is also desired that such a fiber optic lighting system be capable of effectively directing all the emitted light in a forward direction at nearly the same angle over a large area.

### SUMMARY OF INVENTION

The subject invention comprises a lighting assembly that comprises a wave-guide, and a light source. In varying embodiments of the subject invention, the wave-guide can be combined with either a reflective or refractive prism. The subject invention can optionally include a light pipe that is positioned to transfer light from the light source to the wave-guide. Thus, the wave-guide is arranged and disposed in the lighting assembly to allow light emitted from either the light source or the light pipe to enter into the wave-guide. Further, the wave-guide can either comprise a wedge shape wave-guide or a Fresnel wave-guide.

In the lighting assembly, a light ray emits from the light source and either passes into the wave-guide or passes into a light pipe where it travels by total internal reflection through the light pipe into the wave-guide. The wave-guide then selects the output of the light so that it will only be admitted at an angle less than the critical angle. Various embodiments of the subject invention ensure that the light only exits one side of the wave-guide. One such embodiment has a refractive Fresnel prism placed adjacent to the wave-guide that has an index of refraction that is greater than the index of refraction of air and less than the index of refraction of the wave-guide. In this embodiment, the light rays are admitted into the refractive Fresnel prism from the face of the wave-guide, pass through the refractive Fresnel prism and are emitted at a near normal angle.

Another embodiment has a reflective Fresnel prism placed adjacent to the wave-guide with an index of refraction that is greater than the index of refraction of air and less than the index of refraction of the wave-guide. In this embodiment, the light rays are admitted into the reflective Fresnel prism's smooth side and are incident on its grated side. The light rays are reflected back at normal, travel back through the reflective Fresnel prism and are emitted from the lighting assembly through the face of the wave-guide at a near normal angle. Other embodiments have either a reflective coating placed on one side of the wave-guide or a reflective surface placed adjacent to one side of the wave-guide to cause the light to only exit one side of the wave-guide.

### BRIEF DESCRIPTION OF DRAWINGS

FIG. 1 is a side perspective view of a light pipe construction known in the art;

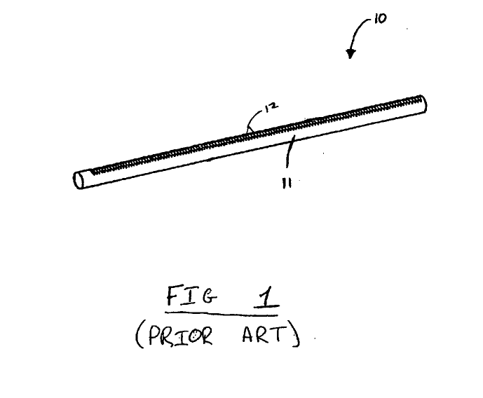

FIG. 2 is a side perspective view of a planar wave-guide assembly known in the art;

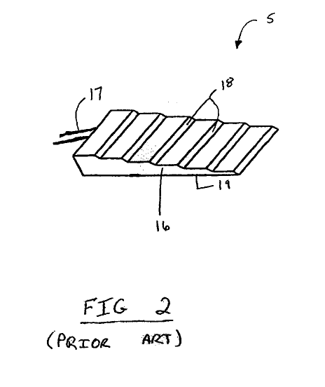

FIG. 3 is a front view of one exemplary embodiment of the subject invention;

FIG. 4a is a cross-sectional view along line A-A of FIG. 3 of the exemplary embodiment of the subject invention;

FIG. 4b is a cross-sectional view along line A-A of FIG. 3 where the exemplary embodiment further comprises a light pipe;

FIG. 5 is a side view of an exemplary embodiment of a wave-guide utilized in the subject invention depicting two light rays approaching the critical angle as they propagate down the wedge shaped wave-guide;

FIG. 6 is a side view of an exemplary embodiment of the subject invention with a refractive medium placed adjacent to the face of the wave-guide;

FIG. 7 is a side view of an exemplary embodiment of the subject invention with a reflective coating placed on the back side of the wave-guide;

FIG. 8 is a side view of an exemplary embodiment of the subject invention with an offset reflective surface placed next to the back side of the wave-guide;

FIG. 9 is the exemplary embodiment of the subject invention of FIG. 7 that further contains an offset refractive Fresnel prism placed next to the face of the wave-guide;

FIG. 10 is a side view of an exemplary embodiment of the subject invention of FIG. 8 that further contains an offset refractive Fresnel prism placed next to the face of the wave-guide;

FIG. 11 is a side perspective view of an automobile utilizing the exemplary embodiment of FIG. 4a as an automotive headlamp wherein the wave-guide and reflective Fresnel prism are shaped to meet the contours of the automobile;

FIG. 12 is a side cross-sectional view of the exemplary embodiment of FIG. 11 along line C-C;

FIG. 13 is a front view of a circular lighting system embodiment of the subject invention;

FIG. 14 is a side cross-sectional view of the exemplary embodiment of FIG. 13 along line B-B of FIG. 13;

FIG. 15 is a side view of an exemplary embodiment of the subject invention utilizing a Fresnel wave-guide; and

FIG. 16 is a side view of the Fresnel wave-guide utilized in the exemplary embodiment of FIG. 15 depicting two light rays approaching the critical angle as they propagate down the Fresnel wave-guide.

### DETAILED DESCRIPTION

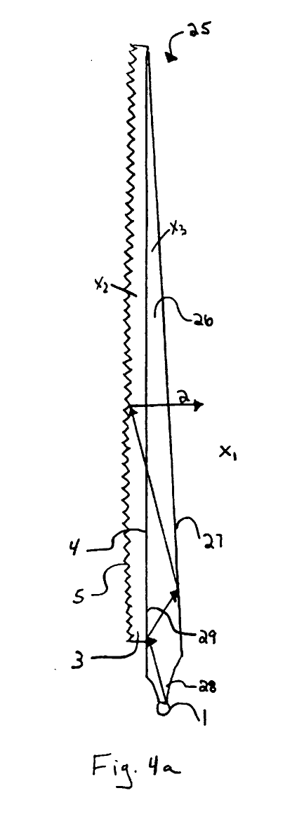

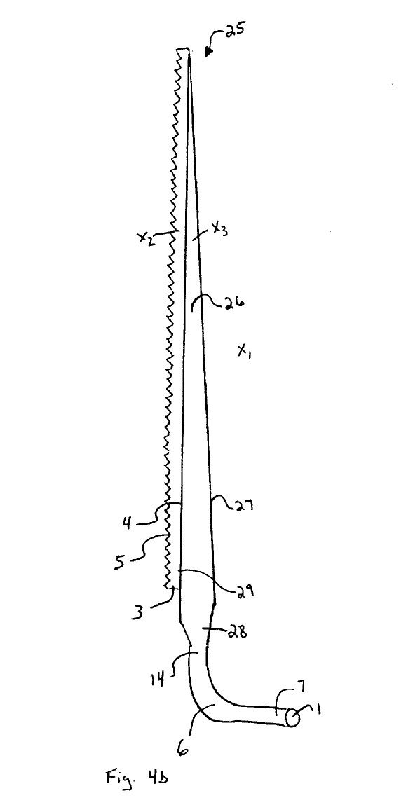

The subject invention comprises a lighting assembly that utilizes an optical device to advantageously direct light emitted from a light source. Specifically, one embodiment of the subject invention comprises a lighting assembly that utilizes an optical device that comprises a wave-guide. Light source 1 (see FIGS. 4a and 4b) can comprise one or more light emitting diodes (“LEDs”). However, it will be appreciated by those of ordinary skill in the art that light source 1 could comprise any other type of light source, such as a conventional filament bulb. Any embodiment of the subject invention using any type of light source is intended to fall within the scope of the subject invention.

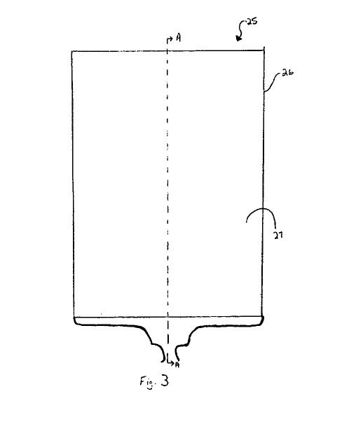

FIG. 3 is a front view of an exemplary embodiment of the subject invention. As shown in FIG. 3, the exemplary embodiment comprises a lighting system 25 that comprises a wave-guide 26 with a face 27. FIG. 4a is a cross-sectional side view of lighting system 25 along line A-A of FIG. 3. Wave-guide 26 has a light emitting portion that in this embodiment comprises face 27. Wave-guide also comprises a light admitting end 28 and a back side 29. While one side of wave-guide 26 is labeled as the face and one side is labeled as the back side, it will be appreciated by one skilled in the art that there is no difference between the front and back side and either surface can function as the back side or as the face of the wave-guide for the subject invention. In this exemplary embodiment, a light source 1 is arranged and disposed to emit light into light admitting end 28 of wave-guide 26 by means known to those skilled in the art.

As shown in FIG. 4a, lighting system 25 further comprises a reflective prism. In this embodiment, the reflective prism comprises reflective Fresnel prism 3 with a smooth side 4 and a grated side 5. As used herein, the phrase “grated side” means a side comprising a plurality of facets. Reflective Fresnel prism 3 has an index of refraction (X₂) that is less than the index of refraction (X₃) of wave-guide 26 and greater than the index of refraction (X₁) of a third medium, such as air, located adjacent to face 27 of the wave-guide. Reflective Fresnel prism 3 is placed adjacent to wave-guide 26 so that smooth side 4 of the reflective Fresnel prism interfaces with back side 29 of the wave guide. As used herein, the term “adjacent” with respect to a wave-guide means a medium located directly against the wave-guide without any intervening medium being in between the wave-guide and the medium. It will be appreciated by one skilled in the art that reflective Fresnel prism 3 can be placed adjacent to either face 27 or back side 29, as long as, the third medium is adjacent to the opposite side from the reflective Fresnel prism of the wave-guide.

In operation, light source 1 will emit a light ray 2. Light ray 2 will enter wave-guide 26 through light admitting end 28. Light ray 2 will reflect off of face 27 and back side 29 until it reaches an angle that is less than the critical angle that will allow the light ray to enter into reflective Fresnel prism 3. In this embodiment, because index of refraction (X₂) of reflective Fresnel prism 3 is greater than the index of refraction (X₁) of air and less than the index of refraction (X₃) of wave-guide 26, nearly all the light rays emitted by light source 1 will exit out of back side 29 of wave-guide 26 and will pass into the reflective Fresnel prism 3. Because of this relationship between the indexes of refraction, the critical angle required to exit into the reflective Fresnel prism will be greater than the critical angle required to exit into air. Thus, light ray 2 will reach an angle less than the critical angle needed to be refracted by back side 29 before it reaches an angle less than the critical angle needed to be refracted by face 27. Light ray 2 enters into reflective Fresnel prism 3 through smooth side 4, reflects off of grated side 5, passes back through wave-guide 26, and exits from face 27 of the wave-guide at nearly a normal angle.

As shown in FIG. 4b, another exemplary embodiment of lighting assembly 25 may further comprise a light pipe 6 that transfers light from light source 1 to wave-guide 26. Light pipe 6 comprises a light admitting end 7 that is positioned next to light source 1 and a light emitting end 14 that is positioned next to wave-guide's 26 light admitting end 28 so that light will transfer from light source 1 to wave-guide 26. In this exemplary embodiment, light pipe 6 is positioned next to light source 1 and wave-guide's 26 light admitting end 28 by means well known in the art, such as using a coupler and index matching gel. It will be appreciated by one skilled in the art that many equivalent types of materials and manufacturing processes exist and may be used to produce light pipe 6 of the subject invention. Light will pass from light source 1 through light pipe 6 by total internal reflection and will enter wave-guide 26 through its light admitting end 28. As described in relation to FIG. 4a, wave-guide 26 and reflective Fresnel prism 3 will cause the light to be emitted out of the wave-guide's face 27 at near normal angles.

It will be appreciated by those of skill in the art that light source 1 can be positioned next to either light admitting end 28 of wave-guide 26 or light admitting end 7 of light pipe 6 using any number of ways known in the art. For example, light source 1 can be positioned next to the light admitting end of the wave-guide or light pipe by a couple and index matching gel or by heat staking the light source to the light admitting end of the wave-guide or light pipe.

In this embodiment, reflective Fresnel prism 3 can comprise a Fresnel prism with a reflective coating placed on grated side 5 of the reflective Fresnel prism.

Suitable reflective coatings include, but are not limited to, chrome, aluminum and stainless steel. It will be appreciated by one skilled in the art that other suitable materials can be used to create the reflective coating on grated side 5 of reflective Fresnel prism 3. While it will be appreciated by one skilled in the art that many suitable materials exist to manufacture reflective Fresnel prism 3, suitable materials used to manufacture reflective Fresnel prism include, but are not limited to, glass, acrylic and polycarbonate.

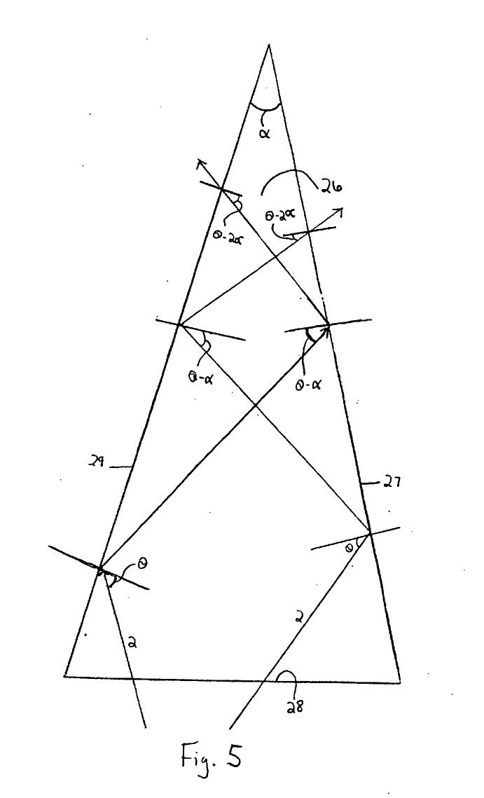

FIG. 5 shows that light rays 2 entering wave-guide 26 will reflect off of back side 29 and face 27 until they reach an angle that is less than the critical angle, at which point the light rays will exit either the back side or the face of the wave-guide at approximately the same angle. Wave-guide 26 has a wedge shaped design. As used herein, the phrase “wedge shape” is defined as a design that is thick at one edge and tapers to a thinner edge at the other edge. Because of wave-guide's 26 structure, the wave-guide is able to select and emit light rays with approximately the same exiting angle.

As shown in FIG. 5, two light rays 2 enter light admitting end 28 of wave-guide 26 and then reflect down back side 29 and face 27 of the wave-guide until the incident angle 0 of each of the light rays is less than the critical angle. Due to the non-parallel orientation of face 27 and back side 29 of wave-guide 26, each of light rays' 2 incident angle θ decreases by the amount of an apex angle α of the wave-guide with each reflection that occurs (θ−α). As light rays 2 propagate down wave-guide 26 they approach the boundary between reflection and refraction, otherwise known as the critical angle. Once each light ray 2 reaches an angle less than the critical angle, it will be refracted out of wave-guide 26 instead of reflected back into the wave-guide. Each light ray 2 approaches the critical angle at the same rate, because each light ray decreases by the amount of apex angle α with each reflection until it reaches an angle less than the critical angle at which point it refracts out of wave-guide 26. Therefore, wave-guide 26 will cause light rays 2 to exit at approximately the same exiting angle. While apex angle α has no minimum or maximum requirement, it will be appreciated by one skilled in the art that the smaller the apex angle is made, the closer the escaping angles of the light rays will be and the more angular control of the exiting light a designer will have.

As shown in FIG. 5, wave-guide 26 allows light to exit out both face 27 and back side 29 of the wave-guide. While some uses of the subject invention might require this embodiment to meet its lighting requirements, other uses of the subject invention might require the light to be directed out of only a light emitting portion of the wave-guide. For example, in order to make a wave-guide lighting system most effective for vehicular applications, such as automobiles, an embodiment of the subject invention needs to have all the light exit either from its back side 29 or its face 27. Various exemplary embodiments of the subject invention exist that ensure that nearly all the light will exit out of either back side 29 or face 27 of wave-guide 26. Two such embodiments were described above in relation to FIGS. 4a and 4b which combine reflective Fresnel prism 3 with wave-guide 26 to create lighting system 25.

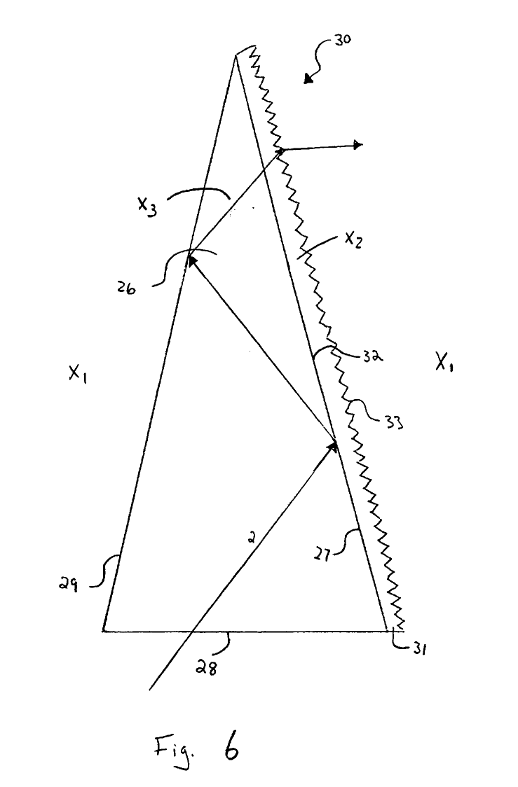

As shown in FIG. 6, another exemplary embodiment comprises a lighting system 30 that combines wave-guide 26 with a refractive prism. In this embodiment, the refractive prism comprises Fresnel prism 31 with a smooth side 32 and a grated side 33. Refractive Fresnel prism 31 is placed adjacent to wave-guide 26 so that smooth side 32 of the refractive Fresnel prism interfaces with face 27 of the wave-guide. Refractive Fresnel prism 31 comprises an index of refraction (X₂) that is less than the index of refraction (X₃) of wave-guide 26 and greater than the index of refraction (X₁) of a third medium, such as air, located adjacent to back side 29 of the wave-guide. It will be appreciated by one skilled in the art that refractive Fresnel prism 31 can be placed adjacent to either face 27 or back side 29 of wave-guide 26 as long as the third medium is placed adjacent to the opposite side from the refractive Fresnel prism of the wave-guide. Suitable materials that can be used to construct refractive Fresnel prism 31 include, but are not limited to, glass, acrylic and polycarbonate.

In operation, light ray 2 will enter wave-guide 26 through its light admitting end 28 either from light source 1 (not pictured in FIG. 6) or from light emitting end 14 of light pipe 6 (not pictured in FIG. 6). Light ray 2 will reflect off of face 27 and back side 29 until it reaches an angle that is less than the critical angle. At that point, light ray 2 will enter into refractive medium 31. In this embodiment, nearly all the light rays emitted by light source 1 will exit out face 27 because index of refraction (X₂) of refractive Fresnel prism 31 is greater than the index (X₁) of refraction of air and less than the index of refraction (X₃) of wave-guide 26. Because of the relationship between these indexes of refraction, the critical angle required to exit into the refractive medium will be greater than the critical angle required to exit into air. Thus, light ray 2 will reach an angle that is less than the critical angle needed to be refracted by face 27 before it reaches an angle that is less than the critical angle needed to be refracted by back side 29. Light ray 2 will pass through refractive Fresnel prism 31 and be refracted by the refractive Fresnel prism so that it exits at a near normal angle.

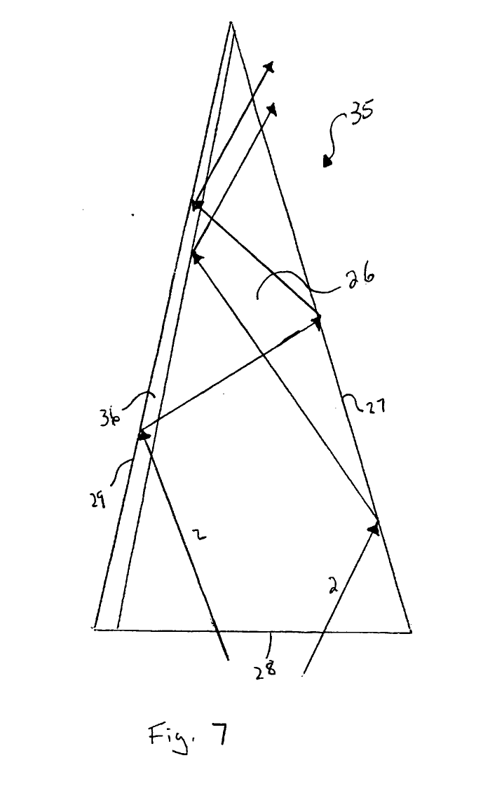

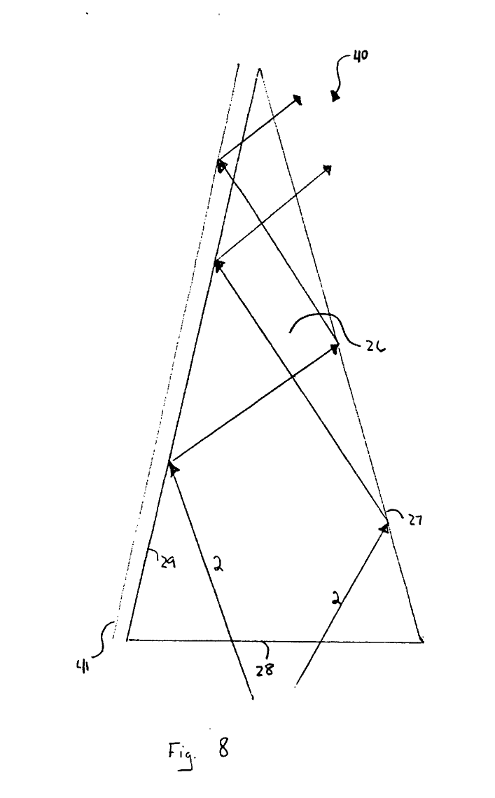

As shown in FIG. 7, another exemplary embodiment comprises a lighting system 35 that comprises wave-guide 26 with a reflective substrate coating 36 placed on back side 29 of the wave-guide. While reflective substrate coating 36 is placed on back side 29, one skilled in the art realizes that the reflective coating can be placed on either the back side or face 27 of wave-guide 26. Suitable reflective substrate coatings include, but are not limited to, aluminum, chrome and stainless steel. It will be appreciated by one skilled in the art that other suitable substrates could be used to construct this embodiment. Further, it will be appreciated by one skilled in the art that reflective coating 36 can be placed on back side 29 in any number of ways, such as using a vacuum metallization process. The operation of the exemplary embodiment of FIG. 7 is described below in conjunction with the operation of the exemplary embodiment of FIG. 8.

As shown in FIG. 8, another exemplary embodiment comprises a lighting assembly 40 that combines a reflective surface 41 and a wave-guide 26. In this exemplary embodiment, reflective surface 41 is placed slightly offset from wave-guide's 26 back side 29. It will be appreciated by one skilled in the art that reflective surface 41 can be placed slightly offset from either back side 29 or face 27 of wave-guide 26. Suitable materials used to manufacture reflective surface 41 include, but are not limited to, aluminum, chromium and stainless steel. It will be appreciated by one skilled in the art that other suitable materials can be used to create reflective surface 41. It will also be appreciated by one skilled in the art that reflective surface 41 can be placed slightly offset from back side 29 in any number of ways, such as, making it part of a secondary housing or using a matching gel.

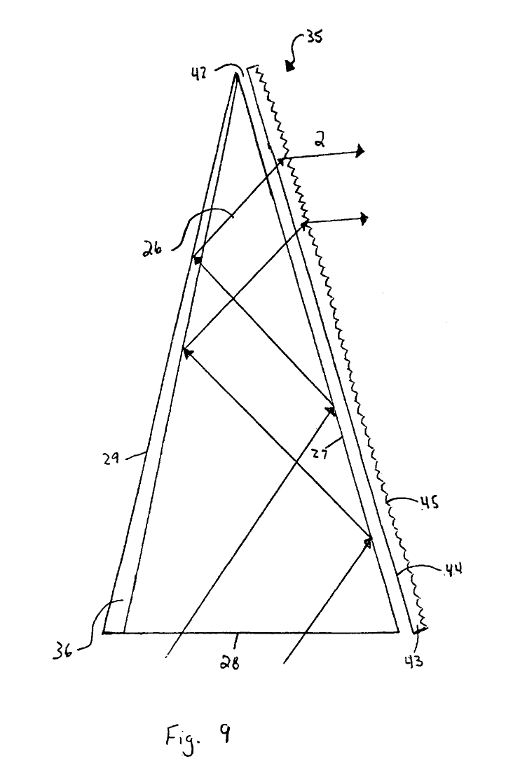

In operation, both lighting systems 35 and 40 operate in similar ways. As shown in FIGS. 7 and 8, light rays 2 will enter wave-guide 26 through its light admitting end 28 either from a light source (not pictured) or from the light emitting end of a light pipe (not pictured). Light rays 2 will reflect off of back side 29 and face 27 until they reach an angle that is less than the critical angle needed to exit wave-guide 26. In lighting system 35 of FIG. 7, light rays 2 will only be allowed to exit face 27 because any light ray that reaches the necessary angle to exit back side 29 will be reflected back through wave-guide 26 by reflective coating 36 until the light ray exits face 27. As shown in FIG. 9, lighting system 35 can further contain a refractive Fresnel prism 43 with a smooth side 44 and a grated side 45. Refractive Fresnel prism 43 is placed slightly offset from wave-guide 26 maintaining an air gap 42. Thus, as light rays 2 exit wave-guide 26 they will pass through air gap 42 and into refractive Fresnel prism 43. Refractive Fresnel prism 43 will refract light rays 2 in such a manner that the light rays will exit lighting system 35 at nearly a normal angle.

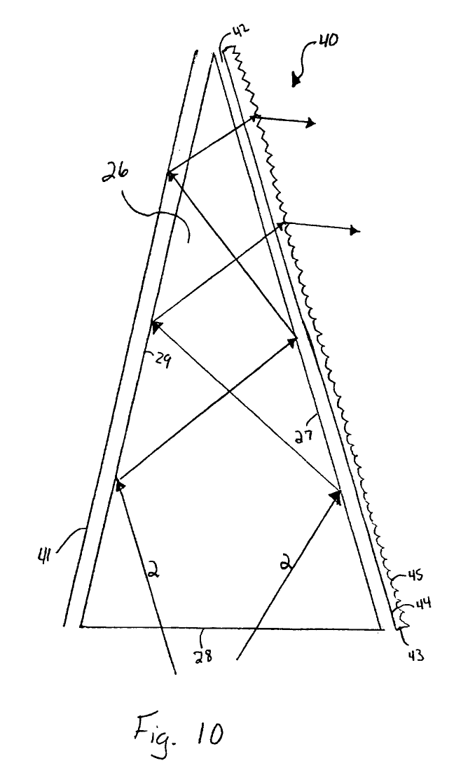

In lighting system 40 of FIG. 8, light rays 2 will be able to exit both back side 29 and face 27 once the light ray reaches an angle less than the critical angle. However, any light ray 2 that exits back side 29 will be reflected by reflective surface 41 so that the light ray will pass back through wave-guide 26 and exit face 27 of the wave-guide. As shown in FIG. 10, lighting system 40 can further contain refractive Fresnel prism 43 with smooth side 44 and grated side 45. Refractive Fresnel prism 43 is placed slightly offset from wave-guide 26 maintaining an air gap 42 with its smooth side 44 facing face 27 of wave-guide 26. Thus, as light rays 2 exit wave-guide 26 it will pass through air gap 42 and into refractive Fresnel prism 43. Refractive Fresnel prism 43 will refract light rays 2 in such a manner that the light rays will exit lighting system 40 at nearly a normal angle.

In the above-described exemplary embodiments of FIGS. 6 and 9-10, suitable materials used to manufacture refractive Fresnel prism 43 include, but are not limited to, glass, aluminum and polycarbonate. It will be appreciated by one skilled in the art that other suitable materials can be used to create the refractive Fresnel prism.

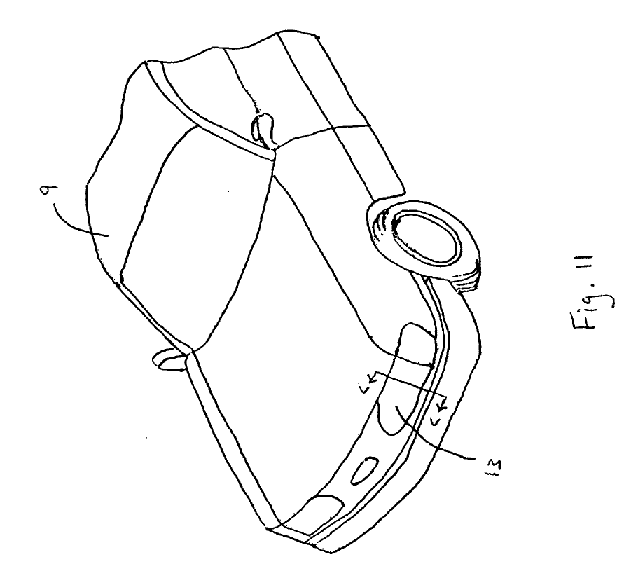

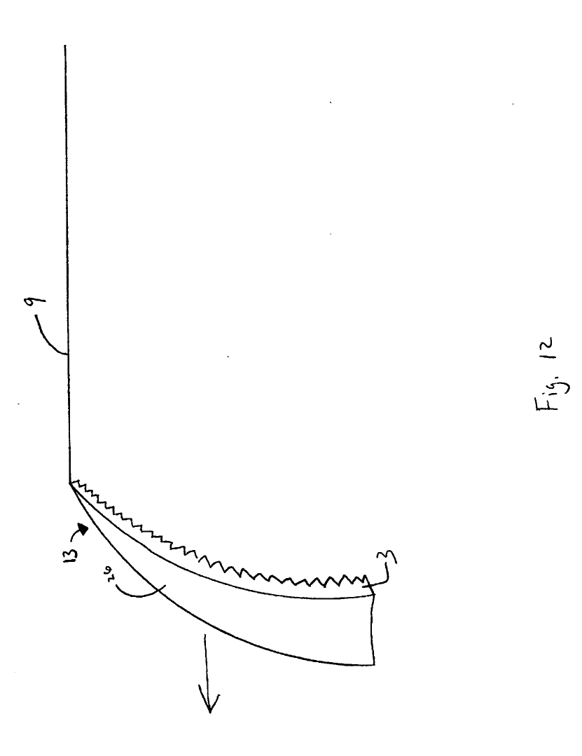

The subject invention can be utilized to construct automotive lighting systems. For example, FIG. 11 shows wave-guide 26 of the exemplary embodiment of FIG. 4a utilized as a headlamp 13 in an automobile 9. FIG. 12 shows a cross-sectional side view of the exemplary embodiment of FIG. 11 along line C-C. As can be seen in FIG. 12, wave-guide 26 and reflective Fresnel prism 3 are shaped to meet the contours of automobile 9. Suitable materials used to manufacture wave-guide 26 include, but are not limited to, glass, acrylic or polycarbonate. Further, wave-guide 26 can be manufactured by an injection molding process. It will be appreciated by one skilled in the art that many equivalent types of materials and manufacturing processes exist and may be used to produce a suitable wave-guide to be used in the subject invention.

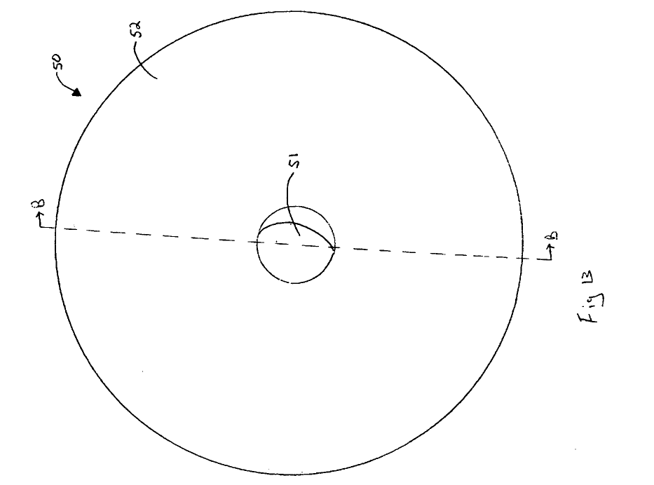

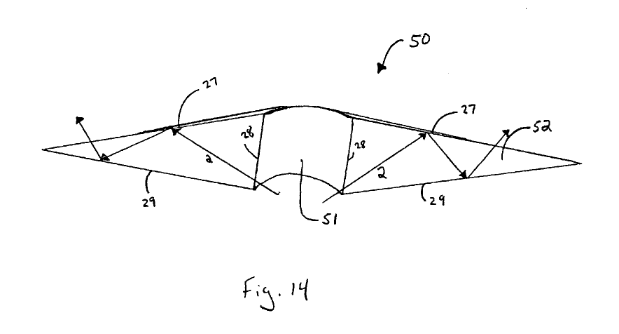

Further, wave-guide 26 can be used to construct lighting systems of other shapes. For example, as shown in FIG. 13, circular lighting system 50 comprises a circular wave-guide 52 and a recess 51. FIG. 14 shows a cross section of circular wave-guide along line B-B of FIG. 13. As shown in FIG. 14, circular wave-guide 52, like wave-guide 26, comprises a light emitting portion, which in this embodiment comprises face 27. Further, wave-guide 26 comprises back side 29 and light admitting end 28. One skilled in the art realizes that a light source (not pictured) or a light emitting end of a light pipe (not pictured) can be placed in recess 51. In operation, light emitted either from the light source or from the light emitting end of the light pipe will pass into light admitting end 28 of circular wave-guide 52. Light rays 2 will reflect off face 27 and back side 29 until they reach an angle that is less than the critical angle, at which point it will pass through either back side 29 or face 27. One skilled in the art realizes that circular wave-guide 52 can be combined with a reflective Fresnel prism, a refractive Fresnel prism, a reflective surface or a reflective coating in the ways described in the previous embodiments to ensure light rays 2 will be emitted through face 27 of the circular wave-guide.

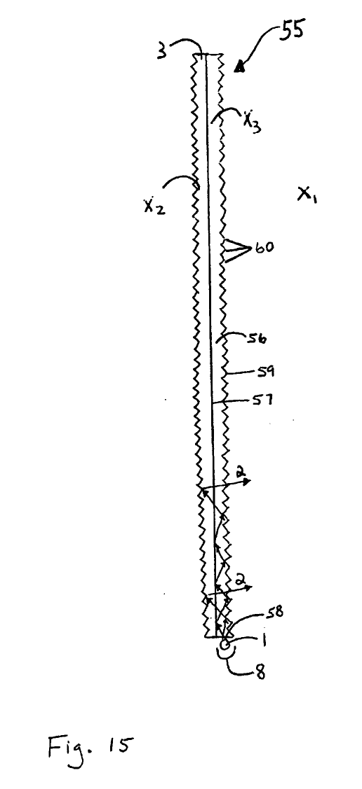

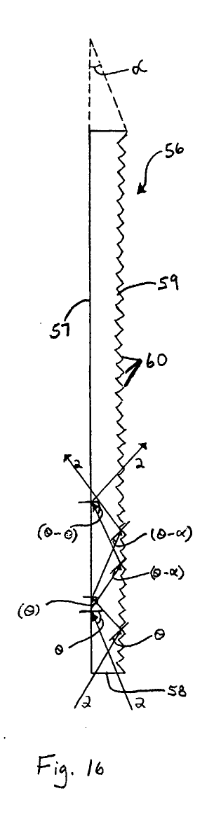

FIG. 15 shows a side view of another exemplary embodiment of the subject invention that utilizes a Fresnel wave-guide 56 instead of a wedge shaped wave-guide. As shown in FIG. 15, the exemplary embodiment comprises a lighting system 55 that comprises Fresnel wave-guide 56 and reflective Fresnel prism 3. Referring to FIG. 16, Fresnel wave-guide 56 comprises a back side 57, a light admitting end 58, and a face 59 made up of a plurality of facets 60. In operation, light rays 2 enter light admitting end 58 and then reflect down back side 57 and face 59. Due to the plurality of facets 60, each of light rays' 2 incident angle θ decreases by the amount of an imaginary apex angle α of the Fresnel wave-guide 56 with each reflection that occurs (θ−α) off of the facets 60. The imaginary apex angle α is shown in FIG. 16 by the dotted lines. Light ray 2 will enter Fresnel wave-guide 56 and reflect off of either back side 57 or facets 60 at an incident angle θ. Referring to the light ray that initially reflects off of facets 60, the light ray will reflect off of back side 57 at the same angle θ and then reflect off of facets 60 at angle (θ−α). Thus, the light ray's angle of reflection will only decrease by α when it reflects off of facets 60. Once each light ray 2 reaches an angle less than the critical angle, it will be refracted out of Fresnel wave-guide 56. Fresnel wave-guide 56 will cause light rays 2 to exit at approximately the same exiting angle because each light ray will approach the critical angle at the same rate. Therefore, just like wave-guide 26, Fresnel wave-guide 56 is able to select and emit light rays 2 with approximately the same exiting angle.

One skilled in the art realizes that Fresnel wave-guide 56 can be combined with a reflective Fresnel prism, a refractive Fresnel prism, a reflective surface or a reflective coating in the ways described in the previous embodiments to ensure light rays 2 will be emitted through face 59 of the Fresnel wave-guide. For example, referring back to FIG. 15, lighting system 55 comprises reflective Fresnel prism 3, Fresnel wave-guide 56, light source 1, and a reflector 8. In this embodiment, wave-guide 56 has a light emitting portion that comprises face 59 made up of plurality of facets 60. Further, reflective Fresnel prism 3 is placed adjacent to Fresnel wave-guide 56 so that its smooth side 4 interfaces with back side 57 of the Fresnel wave-guide. Reflective Fresnel prism 3 has an index of refraction (X₂) that is less than the index of refraction (X₃) of wave-guide 56 and greater than the index of refraction (X₁) of a third medium, such as air, located adjacent to face 59 of the wave-guide. Light source 1 is positioned next to light admitting end 58 of Fresnel wave-guide 56 so that light rays 2 will enter into the Fresnel wave-guide. Reflector 8 is positioned behind light source 1 to further direct light toward light admitting end 58. One skilled in the art realizes that this embodiment could further comprise light pipe 6 (see FIG. 4b) with its light admitting end 7 positioned next to light source 1 and its light emitting end 14 positioned next to light admitting end 58 of Fresnel wave-guide 56, so that light rays 2 will pass from the light source through the light pipe and into the Fresnel wave-guide.

Referring to FIG. 15, in operation, light rays 2 will enter Fresnel wave-guide 56 through its light admitting end 58 either from light source 1 or from light emitting end 14 of light pipe 6 (not pictured in FIG. 15). Light rays 2 will reflect off of face's 59 plurality of facets 60 until they reach an angle that is less than the critical angle. At that point, light rays 2 will enter into reflective Fresnel prism 3. In this embodiment, nearly all light rays 2 emitted by light source 1 will exit out back side 57 because index of refraction (X₂) of reflective Fresnel prism 3 is greater than the index of refraction (X₁) of air and less than the index of refraction (X₃) of wave-guide 26. Because of the relationship between these indexes of refraction, the critical angle required to exit into reflective Fresnel prism 3 will be greater than the critical angle required to exit into air, or any other medium, placed adjacent to face 59. Thus, light rays 2 will reach angles that are less than the critical angle needed to be refracted by back side 57 before they reach an angle that is less than the critical angle needed to be refracted by face 59. Light rays 2 will enter into reflective Fresnel prism 3 through smooth side 4, reflect off of grated side 5, then pass back through Fresnel wave-guide 56, and exit from face 59 of the Fresnel wave-guide at nearly a normal angle.

As described herein, one envisioned, though not limiting, use of the subject invention is as a vehicle headlamp assembly. However, it will be appreciated by one of skill in the art that there are many possible uses, such as any type of vehicle light assembly or any other type of general lighting application.

Although the foregoing describes several embodiments of the invention, one of skill in the art will recognize that other advantages, features and modifications may exist. For example, any of the embodiments described herein can further comprise a lens to help further direct and aim the light admitted by the lighting systems. Further, any of the embodiments described can further comprise a reflector around the light source to help direct all the emitted light by the light source into the wave-guide or light pipe. Additionally, to maximize the efficiency of the wave-guide, the face of the wave-guide and the back side of the wave-guide can be coated with an anti-reflective coating to allow a higher percentage of light to exit the wave-guide when it reaches an angle less than the critical angle. Further, while the embodiments disclosed above disclose the use of a Fresnel prism, it will be appreciated by one skilled in the art that any prism or any other type of medium used to direct light that has an index of refraction (X₂), as described above, can be utilized in the subject invention to ensure light will exit out of the face of the lighting assembly. It is also understood that the subject invention is not to be limited to the details provided above, but rather may be modified within the scope of the appended claims.

1. A lighting assembly comprising:
a. a wave-guide with a light emitting portion made up of a plurality of facets, a back side, and a light admitting end; and
b. at least one light source positioned to emit light into the light admitting end of the wave-guide.

2. The lighting assembly of claim 1 , further comprising at least one light pipe, the at least one light pipe comprising a light admitting end arranged and disposed to allow light to enter the light pipe from the at least one light source and a light emitting end arranged and disposed to direct light into the light admitting end of the wave-guide.

3. The lighting assembly of claim 1 wherein the at least one light source comprises at least one LED.

4. The lighting assembly of claim 1 wherein the lighting assembly further comprises a reflective prism with a smooth side and a grated side, the reflective prism placed adjacent to the back side of the wave-guide so that the smooth side of the reflective prism interfaces with the back side of the wave-guide, the reflective prism having an index of refraction that is greater than an index of refraction of a medium that is adjacent to the face of the wave-guide and that is less than an index of refraction of the wave-guide.

5. The lighting assembly of claim 1 wherein the lighting assembly further comprises a refractive prism with a smooth side and a grated side, the refractive prism placed adjacent to the light emitting portion of the wave-guide so that the smooth side of the refractive prism interfaces with the light emitting portion of the wave-guide, the refractive prism having an index of refraction that is greater than an index of refraction of a medium that is adjacent to the back side of the wave-guide and that is less than an index of refraction of the wave-guide.

6. The lighting assembly of claim 1 wherein the light emitting portion and the back side of the wave-guide are coated with an anti-reflective coating.

7. A lighting assembly comprising:
a. a wedge shaped wave-guide with a light emitting portion, a back side, and a light admitting end;
b. a prism with a smooth side and a grated side adjacent to the wedge shaped wave-guide; and
c. at least one light source positioned to emit light into the light admitting end of the wedge shaped wave-guide.

8. The lighting assembly of claim 7 , further comprising at least one light pipe, the at least one light pipe comprising a light admitting end arranged and disposed to allow light to enter the light pipe from the at least one light source and a light emitting end arranged and disposed to direct light into the light admitting end of the wave-guide.

9. The lighting assembly of claim 7 wherein the at least one light source comprises at least one LED.

10. The lighting assembly of claim 7 wherein the at least one light source is arranged and disposed to direct light into the light admitting end of the wedge shaped wave-guide.

11. The lighting assembly of claim 7 wherein the prism comprises a reflective Fresnel prism placed adjacent to the back side of the wave-guide so that the smooth side of the reflective Fresnel prism interfaces with the back side of the wave-guide, the reflective Fresnel prism having an index of refraction that is greater than an index of refraction of a medium that is adjacent to the face of the wave-guide and that is less than an index of refraction of the wave-guide.

12. The lighting assembly of claim 7 wherein the prism comprises a refractive Fresnel prism placed adjacent to the light emitting portion of the wave-guide so that the smooth side of the refractive Fresnel prism interfaces with the light emitting portion of the wave-guide, the refractive Fresnel prism having an index of refraction that is greater than an index of refraction of a medium that is adjacent to the back side of the wave-guide and that is less than an index of refraction of the wave-guide.

13. The lighting assembly of claim 8 wherein the light emitting portion and the back side of the wave-guide are coated with an anti-reflective coating.

14. An optical device for directing light from a light source consisting of:
a. a wedge shaped wave-guide with a light emitting portion, a back side and a light admitting end, such wedge shaped wave-guide having a first index of refraction;
b. a prism placed adjacent to the wedge shaped wave-guide with a smooth side and a grated side, wherein the prism has a second index of refraction that is less than the first index of refraction; and
c. a third medium adjacent to the wedge shaped wave-guide opposite the prism, wherein the third medium has a third index of refraction that is less than the second index of refraction.

15. The optical device for directing light from a light source of claim 14 wherein the prism is a reflective Fresnel prism placed adjacent to the back side of the wave-guide so that the smooth side of the reflective Fresnel prism interfaces with the back side of the wave-guide.

16. The optical device for directing light from a light source of claim 14 wherein the prism is a refractive Fresnel prism placed adjacent to the light emitting portion of the wave-guide so that the smooth side of the refractive Fresnel prism interfaces with the light emitting portion of the wave-guide.

17. The optical device for directing light from a light source of claim 14 wherein the wave-guide is a circular wave-guide.

18. The optical device for directing from a light of claim 14 wherein the third medium is air.

19. A method of automotive lighting comprising the steps of:
a. providing at least one light source;
b. providing a wave-guide with a light emitting portion and a light admitting end;
c. selecting an approximately equal exiting angle for each light ray emitted by the wave-guide by having each light ray emitted by the at least one light source pass through the wave-guide; and
d. causing each light ray to be emitted through the light emitting portion of the wave-guide.

20. The method of automotive lighting of claim 19 further providing at least one light pipe, the at least one light pipe comprising a light admitting end arranged and disposed to allow light to enter the light pipe from the at least one light source and a light emitting end arranged and disposed to direct light into the light admitting end of the wave-guide.

21. The method of automotive lighting of claim 19 wherein the at least one light source comprises at least one LED.

22. The method of automotive lighting of claim 19 wherein the step of causing each light ray to be emitted through the light emitting portion comprises placing a reflective Fresnel prism adjacent to the back side of the wave-guide so that the smooth side of the reflective Fresnel prism having an index of refraction greater than an index of refraction of a medium that is adjacent to the face of the wave-guide and that is less than an index of refraction of the wave-guide.

23. The method of automotive lighting of claim 19 wherein the step of causing each light ray to be emitted through the light emitting portion comprises placing a refractive Fresnel prism adjacent to the face of the wave-guide so that the smooth side of the refractive Fresnel prism interfaces with the face of the wave-guide, the refractive Fresnel prism having an index of refraction greater than an index of refraction of a medium that is adjacent to the back side of the wave-guide and that is less than an index of refraction of the wave-guide.

24. A lighting assembly comprising:
a. a wave-guide, with a light admitting end and a light emitting portion made up of a plurality of angular facets, selecting an approximately equal exiting angle for each light ray emitted by the wave-guide through its light emitting portion;
b. at least one light source providing light arranged and disposed to direct light into the light admitting end of the wave-guide; and
c. a means for causing each light ray traveling through the wave-guide to be emitted from the face of the wave-guide.
